(19) United States
(12) Patent Application Publication
(10) Pub. No.: US 2025/0252272 A1
(43) Pub. Date: Aug. 7, 2025

(54) METHOD AND SYSTEM FOR ARTIFICIAL INTELLIGENCE ASSISTED CONTENT LIFECYCLE MANAGEMENT

(71) Applicant: JPMorgan Chase Bank, N.A., New York, NY (US)

(72) Inventors: W David THOMAS, Glassboro, NJ (US); Marianna DULKINA, Columbus, OH (US); Kevin J MCNAMARA, Newfoundland, NJ (US); Ben NOVAK, Carol Stream, IL (US); Michael HOUDESHELL, Columbus, OH (US); Kenneth KATSMA, Hoffman Estates, IL (US); Mario MACIAS, Plano, TX (US); Preeti GUPTA, Plano, TX (US); Dejan SAVIC, Burleson, TX (US); Elizabeth PARK, Frisco, TX (US); Rohit TALREJA, Hyderabad (IN); Anjana MURALI, Aurora, IL (US)

(73) Assignee: JPMorgan Chase Bank, N.A., New York, NY (US)

(21) Appl. No.: 18/606,363

(22) Filed: Mar. 15, 2024

(30) Foreign Application Priority Data
Feb. 1, 2024 (IN) 202411006894

(51) Int. Cl. G06F 40/40; G06F 3/0484; G06F 40/253

(52) U.S. Cl. CPC G06F 40/40; G06F 3/0484; G06F 40/253

(57) ABSTRACT

A method for facilitating content lifecycle management via artificial intelligence for AI assisted authoring, AI assisted editing, and phased AI on AI recursive authoring and editing is disclosed. The method includes receiving, via an application programming interface, inquiries in a natural language format, each of the inquiries including freeform data; vectorizing the inquiries to generate numeric sequences; identifying, by using a model, topics for each of the inquiries based on the corresponding numeric sequences, each of the topics including a subject matter value and a sentiment value; aggregating information that corresponds to the topics from various sources, the sources including a preconfigured data lake; determining, by using the model, solutions in the natural language format for each of the inquiries based on the aggregated information, the solutions including recommended actions based on a predetermined setting; and generating, by using the model, a response that includes the solutions.

### CROSS-REFERENCE TO RELATED APPLICATIONS

This application claims the benefit of Indian Provisional Patent Application No. 202411006894, filed Feb. 1, 2024, which is hereby incorporated by reference in its entirety.

### BACKGROUND

### 1. Field of the Disclosure

This technology generally relates to methods and systems for content lifecycle management, and more particularly to methods and systems for facilitating artificial intelligence assisted content lifecycle management, artificial intelligence content restructuring, and artificial intelligence assisted authoring from subject matter generation to automated publishing.

### 2. Background Information

Many entities maintain vast collections of data such as, for example, knowledge articles that are usable to facilitate business operations and provide guidance for users. Often, these collections of data include various information in natural language formats. Historically, implementations of conventional content lifecycle management techniques have resulted in varying degrees of success with respect to effective decoding, interpreting, and encoding of the natural language data to enable automated content uplift.

One drawback of implementing the conventional content lifecycle management techniques is that in many instances, standardizing content is difficult due to the various originators of information such as, for example, numerous different authors. As a result, ineffective communication is prevalent for data in natural language formats. Additionally, due to variabilities in natural language data, decoding, interpreting, and encoding messages require heavy investments in knowledge, time, and resources.

Therefore, there is a need for an artificial intelligence assisted system that facilitates content lifecycle management from subject matter generation to automated publishing. The artificial intelligence assisted system may enable automated splitting, bundling, resizing, renaming, and transforming of natural language data for artificial intelligence content restructuring that facilitates editorial review and artificial intelligence assisted authoring with augmented authoring and editing.

The artificial intelligence assisted system may also enable artificial intelligence editorial review and applied artificial intelligence authoring and editing.

### SUMMARY

The present disclosure, through one or more of its various aspects, embodiments, and/or specific features or sub-components, provides, inter alia, various systems, servers, devices, methods, media, programs, and platforms for facilitating artificial intelligence assisted content lifecycle management from subject matter generation to automated publishing with both artificial intelligence assisted authoring and editorial review as well as full artificial intelligence authoring and editorial review.

According to an aspect of the present disclosure, a method for facilitating content lifecycle management via artificial intelligence is disclosed. The method is implemented by at least one processor. The method may include receiving, via an application programming interface, at least one inquiry in a natural language format, each of the at least one inquiry may include freeform data; vectorizing the at least one inquiry to generate at least one numeric sequence; identifying, by using at least one model, at least one topic for each of the at least one inquiry based on the corresponding at least one numeric sequence, each of the at least one topic may include a subject matter value and a sentiment value; aggregating information that corresponds to the at least one topic from at least one source, the at least one source may include a preconfigured data lake; determining, by using the at least one model, at least one solution in the natural language format for each of the at least one inquiry based on the aggregated information, the at least one solution may include at least one recommended action based on a predetermined setting; and generating, by using the at least one model, a response that includes the at least one solution.

In accordance with an exemplary embodiment, the method may further include displaying, via a graphical user interface, the response together with at least one graphical element that is configured to receive a user input, wherein the at least one graphical element may include at least one from among an edit graphical element that enables modification of the response, a regenerate response graphical element that generates a new response, an update response graphical element that incorporates the at least one recommended action into the response, and a publish graphical element that persists the response as documentation.

In accordance with an exemplary embodiment, the method may further include collecting feedback data in real-time for each of the at least one inquiry, wherein the feedback data may include feedback information that corresponds to the at least one solution, the at least one recommended action, and the user input.

In accordance with an exemplary embodiment, the method may further include determining whether at least one data inconsistency exists in the response based on the collected feedback data, the at least one data inconsistency may correspond to a data point in the response; updating the response by removing the data point when the corresponding at least one data inconsistency is determined; and training the at least one model based on the updated response.

In accordance with an exemplary embodiment, the at least one recommended action may include at least one automatically generated prompt that represents the at least one topic, the at least one automatically generated prompt may include a new phrasing that is different than the corresponding at least one inquiry.

In accordance with an exemplary embodiment, the at least one recommended action may include at least one from among an editorial action that relates to recommended phrasing based on a predetermined style guide, a proof-reading action that identifies a plurality of transcription errors, and a summarization action that outlines the at least one topic.

In accordance with an exemplary embodiment, the at least one solution may be determined by using the at least one model based on the aggregated information and user historical data, the user historical data may include at least one from among aggregated historical information from a plurality of users and personal historical information from a user.

In accordance with an exemplary embodiment, the method may further include initiating at least one function to modify the information that corresponds to the at least one topic in the at least one source based on the at least one solution, wherein the at least one function may include at least one from among a generation function, an update function, and a delete function.

In accordance with an exemplary embodiment, the at least one model may include at least one from among a large language model, a deep learning model, a neural network model, a natural language processing model, a machine learning model, a mathematical model, and a process model.

According to an aspect of the present disclosure, a computing device configured to implement an execution of a method for facilitating content lifecycle management via artificial intelligence is disclosed. The computing device including a processor; a memory; and a communication interface coupled to each of the processor and the memory, wherein the processor may be configured to receive, via an application programming interface, at least one inquiry in a natural language format, each of the at least one inquiry may include freeform data; vectorize the at least one inquiry to generate at least one numeric sequence; identify, by using at least one model, at least one topic for each of the at least one inquiry based on the corresponding at least one numeric sequence, each of the at least one topic may include a subject matter value and a sentiment value; aggregate information that corresponds to the at least one topic from at least one source, the at least one source may include a preconfigured data lake; determine, by using the at least one model, at least one solution in the natural language format for each of the at least one inquiry based on the aggregated information, the at least one solution may include at least one recommended action based on a predetermined setting; and generate, by using the at least one model, a response that includes the at least one solution.

In accordance with an exemplary embodiment, the processor may be further configured to display, via a graphical user interface, the response together with at least one graphical element that is configured to receive a user input, wherein the at least one graphical element may include at least one from among an edit graphical element that enables modification of the response, a regenerate response graphical element that generates a new response, an update response graphical element that incorporates the at least one recommended action into the response, and a publish graphical element that persists the response as documentation.

In accordance with an exemplary embodiment, the processor may be further configured to collect feedback data in real-time for each of the at least one inquiry, wherein the feedback data may include feedback information that corresponds to the at least one solution, the at least one recommended action, and the user input.

In accordance with an exemplary embodiment, the processor may be further configured to determine whether at least one data inconsistency exists in the response based on the collected feedback data, the at least one data inconsistency may correspond to a data point in the response; update the response by removing the data point when the corresponding at least one data inconsistency is determined; and train the at least one model based on the updated response.

In accordance with an exemplary embodiment, the at least one recommended action may include at least one automatically generated prompt that represents the at least one topic, the at least one automatically generated prompt may include a new phrasing that is different than the corresponding at least one inquiry.

In accordance with an exemplary embodiment, the at least one recommended action may include at least one from among an editorial action that relates to recommended phrasing based on a predetermined style guide, a proof-reading action that identifies a plurality of transcription errors, and a summarization action that outlines the at least one topic.

In accordance with an exemplary embodiment, the processor may be further configured to determine the at least one solution by using the at least one model based on the aggregated information and user historical data, the user historical data may include at least one from among aggregated historical information from a plurality of users and personal historical information from a user.

In accordance with an exemplary embodiment, the processor may be further configured to initiate at least one function to modify the information that corresponds to the at least one topic in the at least one source based on the at least one solution, wherein the at least one function may include at least one from among a generation function, an update function, and a delete function.

In accordance with an exemplary embodiment, the at least one model may include at least one from among a large language model, a deep learning model, a neural network model, a natural language processing model, a machine learning model, a mathematical model, and a process model.

According to an aspect of the present disclosure, a non-transitory computer readable storage medium storing instructions for facilitating content lifecycle management via artificial intelligence is disclosed. The storage medium including executable code which, when executed by a processor, may cause the processor to receive, via an application programming interface, at least one inquiry in a natural language format, each of the at least one inquiry may include freeform data; vectorize the at least one inquiry to generate at least one numeric sequence; identify, by using at least one model, at least one topic for each of the at least one inquiry based on the corresponding at least one numeric sequence, each of the at least one topic may include a subject matter value and a sentiment value; aggregate information that corresponds to the at least one topic from at least one source, the at least one source may include a preconfigured data lake; determine, by using the at least one model, at least one solution in the natural language format for each of the at least one inquiry based on the aggregated information, the at least one solution may include at least one recommended action based on a predetermined setting; and generate, by using the at least one model, a response that includes the at least one solution.

In accordance with an exemplary embodiment, when executed by the processor, the executable code may further cause the processor to display, via a graphical user interface, the response together with at least one graphical element that is configured to receive a user input, wherein the at least one graphical element may include at least one from among an edit graphical element that enables modification of the response, a regenerate response graphical element that generates a new response, an update response graphical element that incorporates the at least one recommended action into the response, and a publish graphical element that persists the response as documentation.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for facilitating artificial intelligence assisted content lifecycle management, artificial intelligence content restructuring, and artificial intelligence assisted authoring from subject matter generation to automated publishing.

FIG. 4 is a flowchart of an exemplary process for implementing a method for facilitating artificial intelligence assisted content lifecycle management, artificial intelligence content restructuring, and artificial intelligence assisted authoring from subject matter generation to automated publishing.

FIG. 5 is flow diagram of an exemplary content management lifecycle process for implementing a method for facilitating artificial intelligence assisted content lifecycle management, artificial intelligence content restructuring, and artificial intelligence assisted authoring from subject matter generation to automated publishing.

FIG. 6 is a content lifecycle process flow diagram of an exemplary process for implementing a method for facilitating artificial intelligence assisted content lifecycle management, artificial intelligence content restructuring, and artificial intelligence assisted authoring from subject matter generation to automated publishing.

FIG. 7 is a theory model diagram of an exemplary process for implementing a method for facilitating artificial intelligence assisted content lifecycle management, artificial intelligence content restructuring, and artificial intelligence assisted authoring from subject matter generation to automated publishing.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

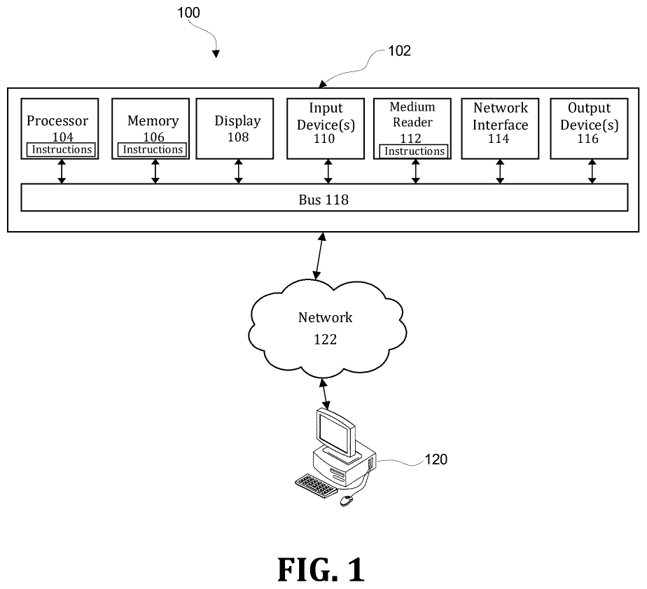

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning system (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons skilled in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a GPS device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for facilitating artificial intelligence assisted content lifecycle management, artificial intelligence content restructuring, and artificial intelligence assisted authoring from subject matter generation to automated publishing.

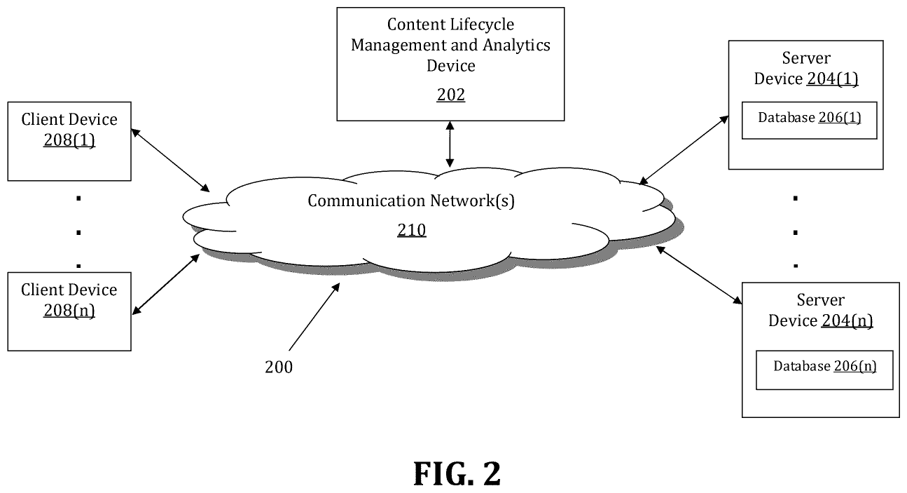

Referring to FIG. 2, a schematic of an exemplary network environment 200 for implementing a method for facilitating artificial intelligence assisted content lifecycle management, artificial intelligence content restructuring, and artificial intelligence assisted authoring from subject matter generation to automated publishing is illustrated. In an exemplary embodiment, the method is executable on any networked computer platform, such as, for example, a personal computer (PC).

The method for facilitating artificial intelligence assisted content lifecycle management, artificial intelligence content restructuring, and artificial intelligence assisted authoring from subject matter generation to automated publishing may be implemented by a Content Lifecycle Management and Analytics (CLMA) device 202. The CLMA device 202 may be the same or similar to the computer system 102 as described with respect to FIG. 1. The CLMA device 202 may store one or more applications that can include executable instructions that, when executed by the CLMA device 202, cause the CLMA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the CLMA device 202 itself, may be located in virtual server(s) running in a cloud-based computing environment rather than being tied to one or more specific physical network computing devices. Also, the application(s) may be running in one or more virtual machines (VMs) executing on the CLMA device 202. Additionally, in one or more embodiments of this technology, virtual machine(s) running on the CLMA device 202 may be managed or supervised by a hypervisor.

In the network environment 200 of FIG. 2, the CLMA device 202 is coupled to a plurality of server devices 204(1)-204(n) that hosts a plurality of databases 206(1)-206(n), and also to a plurality of client devices 208(1)-208(n) via communication network(s) 210. A communication interface of the CLMA device 202, such as the network interface 114 of the computer system 102 of FIG. 1, operatively couples and communicates between the CLMA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the CLMA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and CLMA devices that efficiently implement a method for facilitating artificial intelligence assisted content lifecycle management, artificial intelligence content restructuring, and artificial intelligence assisted authoring from subject matter generation to automated publishing.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The CLMA device 202 may be a standalone device or integrated with one or more other devices or apparatuses, such as one or more of the server devices 204(1)-204(n), for example. In one particular example, the CLMA device 202 may include or be hosted by one of the server devices 204(1)-204(n), and other arrangements are also possible. Moreover, one or more of the devices of the CLMA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the CLMA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to inquiries, natural language data, freeform data, numeric sequences, topics, subject matter values, sentiment values, aggregated information, solutions, recommended actions, predetermined settings, and responses.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the CLMA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the CLMA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the CLMA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the CLMA device 202, the server devices 204(1)-204(n), or the client devices 208(1)-208(n), for example, may be configured to operate as virtual instances on the same physical machine. In other words, one or more of the CLMA device 202, the server devices 204(1)-204(n), or the client devices 208(1)-208(n) may operate on the same physical device rather than as separate devices communicating through communication network(s) 210. Additionally, there may be more or fewer CLMA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

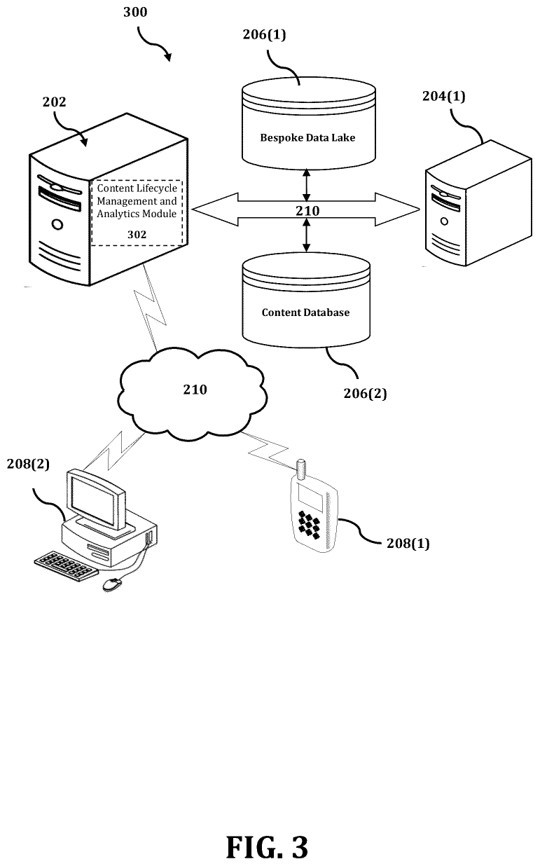

The CLMA device 202 is described and shown in FIG. 3 as including a content lifecycle management and analytics module 302, although it may include other rules, policies, modules, databases, or applications, for example. As will be described below, the content lifecycle management and analytics module 302 is configured to implement a method for facilitating artificial intelligence assisted content lifecycle management, artificial intelligence content restructuring, and artificial intelligence assisted authoring from subject matter generation to automated publishing.

An exemplary process 300 for implementing a mechanism for facilitating artificial intelligence assisted content lifecycle management, artificial intelligence content restructuring, and artificial intelligence assisted authoring from subject matter generation to automated publishing by utilizing the network environment of FIG. 2 is shown as being executed in FIG. 3. Specifically, a first client device 208(1) and a second client device 208(2) are illustrated as being in communication with CLMA device 202. In this regard, the first client device 208(1) and the second client device 208(2) may be “clients” of the CLMA device 202 and are described herein as such. Nevertheless, it is to be known and understood that the first client device 208(1) and/or the second client device 208(2) need not necessarily be “clients” of the CLMA device 202, or any entity described in association therewith herein. Any additional or alternative relationship may exist between either or both of the first client device 208(1) and the second client device 208(2) and the CLMA device 202, or no relationship may exist.

Further, CLMA device 202 is illustrated as being able to access a bespoke data lake 206(1) and a content database 206(2). The content lifecycle management and analytics module 302 may be configured to access these databases for implementing a method for facilitating artificial intelligence assisted content lifecycle management, artificial intelligence content restructuring, and artificial intelligence assisted authoring from subject matter generation to automated publishing.

The first client device 208(1) may be, for example, a smart phone. Of course, the first client device 208(1) may be any additional device described herein. The second client device 208(2) may be, for example, a PC. Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the CLMA device 202 via broadband or cellular communication. Of course, these embodiments are merely exemplary and are not limiting or exhaustive.

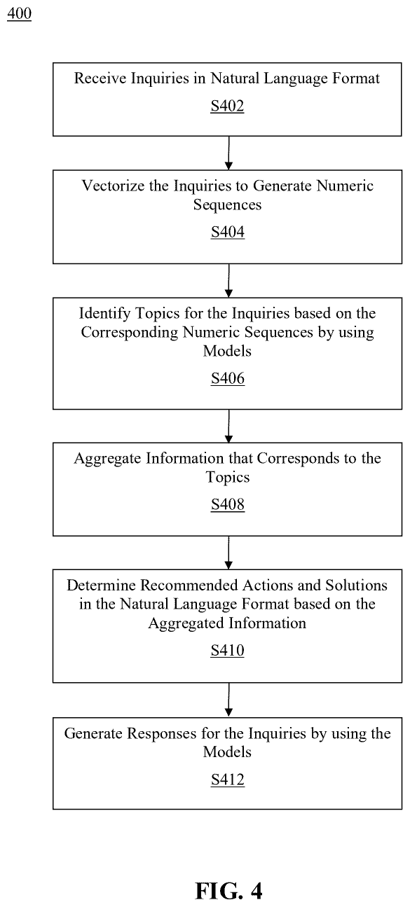

Upon being started, the content lifecycle management and analytics module 302 executes a process for facilitating artificial intelligence assisted content lifecycle management, artificial intelligence content restructuring, and artificial intelligence assisted authoring from subject matter generation to automated publishing. An exemplary process for facilitating artificial intelligence assisted content lifecycle management, artificial intelligence content restructuring, and artificial intelligence assisted authoring from subject matter generation to automated publishing is generally indicated at flowchart 400 in FIG. 4.

In the process 400 of FIG. 4, at step S402, inquiries in a natural language format may be received. The inquiries may be received via an application programming interface. In an exemplary embodiment, the inquiries may include instructions in a natural language format to perform a desired action. Similarly, the inquiries may include a request in a natural language format for information. For example, the inquiries may include instructions to generate content based on a desired topic. Likewise, for example, the inquiries may include a request for information on resetting user passwords. In another exemplary embodiment, the inquiries may be received as a batch of a plurality of inquiries. The batch of inquiries may be automatically parsed for processing consistent with present disclosures.

In another exemplary embodiment, each of the inquiries may include freeform data in any language. The disclosed system may be configured to receive freeform data from a user as unstructured text in any language without regard to length and/or order. The inquiries may be received as any combination of expressions in a natural language format. For example, the inquiries may be received as complete sentences, sentence fragments, and any sequence of words such as “reset password.”

In another exemplary embodiment, the application programming interface may enable the disclosed system to receive the inquiries from any services such as, for example, web services as well as any platforms such as, for example, digital workflow management platforms. Moreover, the disclosed system may be associated with a program and/or piece of software such as, for example, an application that performs a specific function such as, for example, receiving the inquiries.

In another exemplary embodiment, the application may include at least one from among a monolithic application and a microservice application. The monolithic application may describe a single-tiered software application where the user interface and data access code are combined into a single program from a single platform. The monolithic application may be self-contained and independent from other computing applications.

In another exemplary embodiment, a microservice application may include a unique service and a unique process that communicates with other services and processes over a network to fulfill a goal. The microservice application may be independently deployable and organized around business capabilities. In another exemplary embodiment, the microservices may relate to a software development architecture such as, for example, an event-driven architecture made up of event producers and event consumers in a loosely coupled choreography. The event producer may detect or sense an event such as, for example, a significant occurrence or change in state for system hardware or software and represent the event as a message. The event message may then be transmitted to the event consumer via event channels for processing.

In another exemplary embodiment, the event-driven architecture may include a distributed data streaming platform for the publishing, subscribing, storing, and processing of event streams in real time. As will be appreciated by a person of ordinary skill in the art, each microservice in a microservice choreography may perform corresponding actions independently and may not require any external instructions.

In another exemplary embodiment, microservices may relate to a software development architecture such as, for example, a service-oriented architecture which arranges a complex application as a collection of coupled modular services. The modular services may include small, independently versioned, and scalable customer-focused services with specific business goals. The services may communicate with other services over standard protocols with well-defined interfaces. In another exemplary embodiment, the microservices may utilize technology-agnostic communication protocols such as, for example, a Hypertext Transfer Protocol (HTTP) to communicate over a network and may be implemented by using different programming languages, databases, hardware environments, and software environments.

At step S404, the inquiries may be vectorized to generate numeric sequences. In an exemplary embodiment, the natural language data may be converted into the numeric sequence by using a computing component such as, for example, a math engine that transforms linguistic data into computer readable data. The math engine may be usable to convert unstructured natural language data into structured data to facilitate further processing.

In another exemplary embodiment, the generating of the structured data sets may include a first step that encodes the unstructured data and a second step that vectorizes the encoded data. In the first step, the unstructured data is encoded to represent categorical variables as a corresponding numerical value. The encoding may be facilitated by an encoding technique that converts categorical data variables for input in machine learning algorithms.

In the second step, the encoded unstructured data may be vectorized into a plurality of number vectors. The encoded unstructured data may be converted into vectors of real numbers that are supported by machine learning algorithms. The vectorizing of the encoded unstructured data may facilitate extraction of distinct features from the unstructured data.

At step S406, topics may be identified for each of the inquiries based on the corresponding numeric sequences. The topics may be identified for each of the inquiries by using a model. In an exemplary embodiment, the topic may relate to subject matter that is expressed in the inquiries. Consistent with present disclosures, the topic may correspond to any subject matter that serves as a basis for the inquiries. For example, inquiries relating to reserving a desk at work may include a reservation topic as well as a desk topic. Each of the inquiries may include a single topic as well as a plurality of topics based on user preferences.

In another exemplary embodiment, each of the topics may include a subject matter value and a sentiment value. The subject matter value and the sentiment value may be usable as additional components for managing inquires. The subject matter value may relate to a relevancy of the content identified based on the inquiries. For example, a higher subject matter value may identify information as more relevant while a lower subject matter value may indicate that the information is less relevant. The sentiment value may be determined by using real-time sentiment analysis to identify a tone of the inquiry. The tone of the inquiry may assist in providing an appropriate response. For example, the disclosed system may structure the natural language response in a calming manner when an agitated tone is identified in the inquiries.

In another exemplary embodiment, the model may include at least one from among a large language model, a deep learning model, a neural network model, a natural language processing model, a machine learning model, a mathematical model, and a process model. The rephrasing model may also include stochastic models such as, for example, Markov models that are usable to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, support vector machine (SVM) analysis, logistic regression analysis, etc. In another exemplary embodiment, machine learning analytical techniques may include unsupervised learning algorithms such as, for example, Apriori algorithm analysis, K-means clustering analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the machine learning process may include a neural network that relates to at least one from among an artificial neural network and a simulated neural network. The neural network may correspond to a technique in artificial intelligence that teaches computers to process data by using interconnected processing nodes and/or artificial neurons. The neural network may relate to a type of machine learning such as, for example, deep learning that uses interconnected nodes and/or artificial neurons in a layered structure to transform inputs for predictive analytics.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

In another exemplary embodiment, the large language model may relate to a trained deep-learning model that understands and generates text in a human-like fashion. The large language model may recognize, summarize, translate, predict, and generate various types of text as well as content based on knowledge gained from massive data sets. In another exemplary embodiment, the large language model may correspond to a language model that consists of a neural network with many parameters such as, for example, weights. The language model may be trained on large quantities of unlabeled and labeled text by using self-supervised learning or semi-supervised learning. The trained language model may be usable to capture syntax and semantics of human language.

In another exemplary embodiment, the natural language processing model may correspond to a plurality of natural language processing techniques. The natural language processing techniques may include at least one from among a sentiment analysis technique, a named entity recognition technique, a summarization technique, a topic modeling technique, a text classification technique, a keyword extraction technique, and a lemmatization and stemming technique. As will be appreciated by a person of ordinary skill in the art, natural language processing may relate to computer processing and analyzing of large quantities of natural language data.

At step S408, information that corresponds to the topics may be aggregated from a variety of sources. The sources may include internal as well as external sources. Consistent with present disclosures, the information may include any collection of data such as, for example, articles, self-help literatures, and documentations. In an exemplary embodiment, the sources may include a preconfigured data lake such as, for example, a data lake with bespoke data. The data lake may relate to a repository that is designed to store, process, and secure large amounts of structured, semi-structured, and unstructured data. The data lake may store data in a native format for subsequent processing. The bespoke data may include various metadata such as, for example, classification labels that facilitate expedited retrieval of information from the data lake.

In another exemplary embodiment, consistent with present disclosures, the data lake may correspond to a content database that is configured to persist content generated by the disclosed system. The content database may represent at least one from among an integrated data repository that is incorporated into the disclosed system as well as an external data repository of a third-party system where the generated content is maintained. For example, the external data repository may include a self-help articles database in a workflow management platform. Conversely, the integrated data repository may correspond to a computing component that is associated with the data lake. The disclosed system may utilize any combination of data lake and content database as necessary to persist topic information as well as generated content.

In another exemplary embodiment, consistent with present disclosures, the sources may include a content management system such as, for example, a master data management (MDM) content management system. The MDM system may relate to a single master record for all enterprise data from across internal and external data sources as well as applications. The information in the master record may be processed, de-duplicated, reconciled, and enriched to become a consistent as well as reliable source. The master record may serve as a trusted view of critical data that can be managed and shared across an entity to promote accurate reporting, reduce data errors, remove redundancy, and help users make better-informed decisions. For example, the MDM system may be usable to track standing data lineages.

At step S410, solutions in the natural language format may be determined for each of the inquiries based on the aggregated information. The solutions may be determined for each of the inquiries by using the model. In an exemplary embodiment, the solutions may be determined by using the model based on the aggregated information and user historical data. The user historical data may include at least one from among aggregated historical information from a plurality of users and personal historical information from a user. For example, the historical data from a grouping of similar users in a workgroup may indicate a preference for a certain type of content. Likewise, for example, the historical data of a particular user may indicate a tendency to inquire about a particular topic.

In another exemplary embodiment, the solutions may include recommended actions that have been determined based on a predetermined setting such as, for example, a style guide. The recommended actions may include automatically generated prompts that represent the determined topics, as determined by prompt engineering. The automatically generated prompts may include a new phrasing that is different than the corresponding inquiries. For example, the automatically generated prompts may provide different phrasings to inquire about a particular subject to clarify the inquiry for the model.

In another exemplary embodiment, prompt engineering may include the optimizing of prompts for models such as, for example, large language models. The disclosed invention may optimize question prompts for more efficient results. For example, the different phrasings in the automatically generated prompts may improve understanding and perception of ambiguous inquiries. Prompt engineering may enable customizing of outputs from the models.

In another exemplary embodiment, the recommended actions may include at least one from among an editorial action, a proof-reading action, and a summarization action. The editorial action may relate to recommended phrasings based on a predetermined style guide. For example, the editorial action may adjust phrasing of user generated content to match with a predetermined style guide to improve standardization. The proof-reading action may be usable to identify a plurality of transcription errors. For example, the proof-reading action may determine that the user generated content includes misspellings and grammatical mistakes. The summarization action may outline the determined topic. For example, the summarization action may provide a synopsis of the generated content for the user for quick reference.

At step S412, responses to the inquiries may be generated by using the model. The responses to the inquiries may include the determined solution in the natural language format. The responses may also include content in various formats such as, for example, text, images, and videos. Consistent with present disclosures, the responses may include newly generated content, newly split content, newly bundled content, newly resized content, and newly renamed content. In an exemplary embodiment, the responses to the inquiries may be generated in real-time by using the model. The model may be usable to process single inquiries as well as a batch of a plurality of inquiries in real-time. For example, a user may input a batch of self-help documents together with a request for the model to remove duplicate content and generate succinct articles. The disclosed model may process the self-help documents in real-time to generate content consistent with provided user instructions.

In another exemplary embodiment, the responses may be displayed together with graphical elements that are configured to receive a user input. The responses and the graphical elements may be displayed via a graphical user interface. Consistent with present disclosures, the graphical user interface may correspond to a computing component that is usable to receive the initial inquiries.

In another exemplary embodiment, the graphical elements may include at least one from among an edit graphical element, a regenerate response graphical element, an update response graphical element, and a publish graphical element. The edit graphical element may enable modification of the response by the user. For example, a user may interact with the edit graphical element to manually adjust generated content as well as incorporate system recommended information into the generated content. The regenerate response graphical element may instruct the disclosed system to generate a new response with new content. For example, the user may adjust various parameters such as information source and request regeneration of the content based on the changes.

The update response graphical element may incorporate the recommend actions into the response. For example, the user may select certain recommended content phrasings based on a style guide and request incorporation into the generated content. The published graphical element may persist the response as documents in a predefine repository. Consistent with present disclosures, the documents may include article fragments. For example, once the user is satisfied with the generated content, the user may interact with the published graphical element to automatically store the generated content in any desired platform such as a help center database. The disclosed invention may interact with various platforms via application programming interfaces to facilitate automated publishing of the generated content. That is, a user may interact with graphical elements on the graphical user interface to initiate automated publishing of generated content to any platform.

In another exemplary embodiment, user feedback may be aggregated to improve model performance and reduce hallucinations. Feedback data may be collected in real-time for each of the inquiries. The feedback data may be automatically collected based on user interaction with the generated content. For example, the feedback data may include information relating to a number of times the user requested regeneration of the content or a number of changes that the user made to the generated content. The feedback data may also be collected directly from the user. For example, the graphical user interface my generate a prompt to the user inquiring whether the determined topic is accurate. The feedback data may include feedback information that corresponds to the solutions, the recommended actions, and the user inputs.

In another exemplary embodiment, the user feedback data may be usable to further train and refine the model. The iterative process may include determining whether data inconsistencies exist in the response based on the collected feedback data. The data inconsistencies may correspond to a data point in the response. For example, the disclosed system may determine that a data point has been duplicated in the generated content, which is confirmed based on the collected feedback data. Then, the response may be updated to remove the data point when the corresponding data inconsistencies are determined. The model may be trained based on the updated response to reduce the likelihood of similar data inconsistencies appearing in future responses. Consistent with present disclosures, the training and refining of the model may be accomplished in real-time as well as in previously disclosed batch processing mode on the backend.

In another exemplary embodiment, the feedback data may be usable to train the model on the intent of a user's editorial decisions. The model may reformulate future responses as a more efficient composition of results with top articles returned first. The training of the model to identify user intent may assist long-term content uplift for high-quality knowledge content.

In another exemplary embodiment, the training and refining of the model may be usable to reduce flawed results of the model such as, for example, reducing model hallucinations. As used in the present disclosure, model hallucinations may correspond to artificial intelligence hallucinations that result in incorrect and/or misleading outputs generated by machine learning models. Artificial intelligence hallucinations may relate to a phenomenon where a model such as, for example, a large language model perceives patterns and/or objects that are nonexistent and/or imperceptible to human observers. This improper perception may result in outputs that are nonsensical and/or altogether inaccurate.

These output errors may be caused by a variety of factors such as, for example, insufficient training data, incorrect assumptions made by the model, and/or biases in the data. The use of feedback data in the present disclosure to further train and refine the model may provide hallucination mitigation through improved training data that are corrected for assumptions and biases.

In another exemplary embodiment, information at the source may be modified to improve clarity, remove duplication, and enhance accessibility. For example, titles of articles at the source may be updated to further clarify the subject matter within. To facilitate adjustment in source information, functions may be initiated to modify the information that corresponds to the topic in the source based on the solution. The functions may include at least one from among a generation function, an update function, and a delete function. For example, the generation function may be usable when new content has been generated for persistence.

Similarly, for example, the update function may be usable to adjust article names when the solution splits up an article into easier to comprehend components. Likewise, for example, the delete function may be usable to remove articles that have been determined to be duplicates. Consistent with present disclosures, the functions may facilitate disclosed capabilities such as article splitting, article bundling, article resizing, and article renaming.

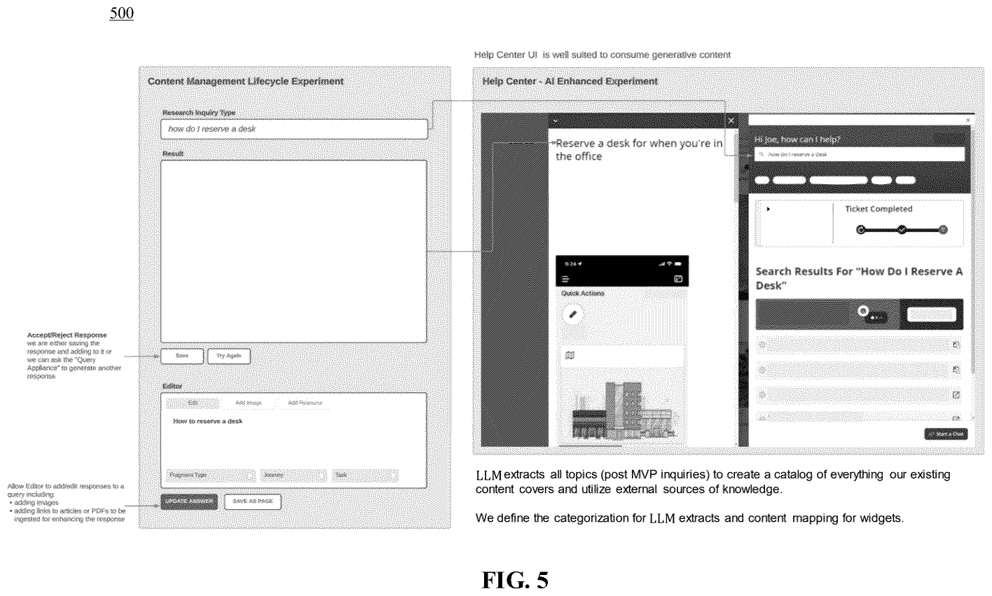

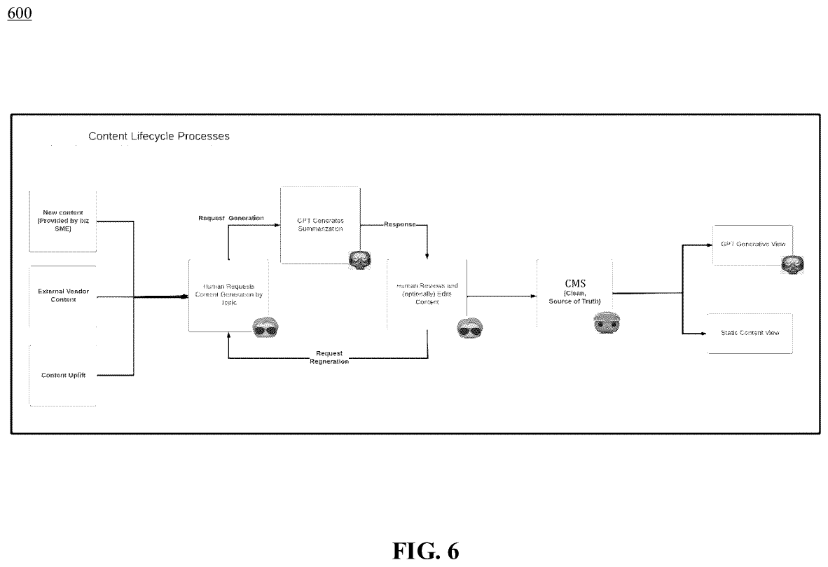

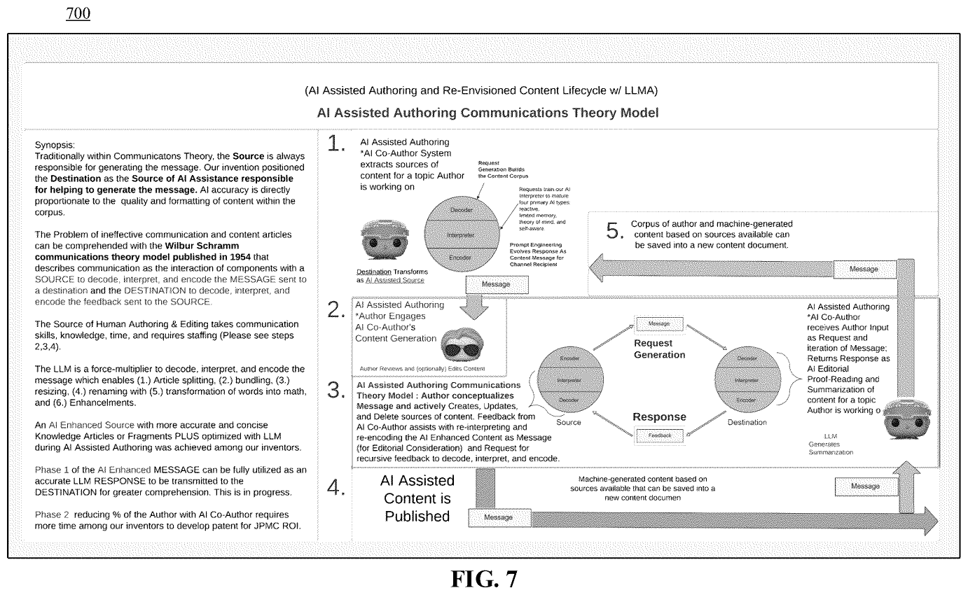

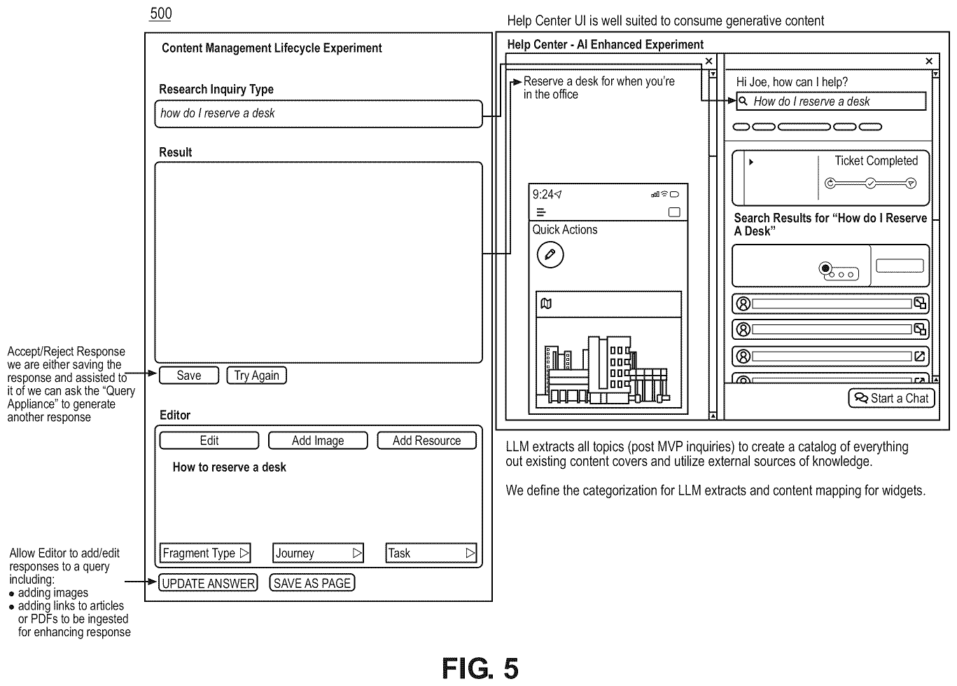

FIG. 5 is flow diagram of an exemplary content management lifecycle process for implementing a method for facilitating artificial intelligence assisted content lifecycle management, artificial intelligence content restructuring, and artificial intelligence assisted authoring from subject matter generation to automated publishing. In FIG. 5, content lifecycle is re-envisioned with large language models. Artificial intelligence enhanced authoring may shorten time to clean-up content and produce next iterations and prompts.

As illustrated in FIG. 5, a user may interact with the disclosed system via a graphical user interface. The graphical user interface may include various graphical elements that are configured to receive input from the user. The graphical user interface may include a “Research Inquiry Type” graphical element that is configured to received freeform natural language inquiries from the user. After receiving the user inquiries, the disclosed system processes the natural language inquiries consistent with present disclosures and return a response in the “Results” graphical element. The response may be generated by using internally as well as externally aggregated information. Generation of the response may be instant as the inquires are processed in real-time.

One the response has been provided, the author has the option to either accept or reject the response. When the response is accepted, the response may be persisted to a predetermined data repository. However, when the response is not accepted, the disclosed system may be instructed to regenerate the response. The graphical user interface may also include an “Editor” graphical element that is usable to modify the response as well as adjust various system parameters. For example, by interacting with the editor, the user may add and/or edit responses to a query to allow the disclosed system to include images in the response as well as links to articles/documents to be ingested for response enhancement.

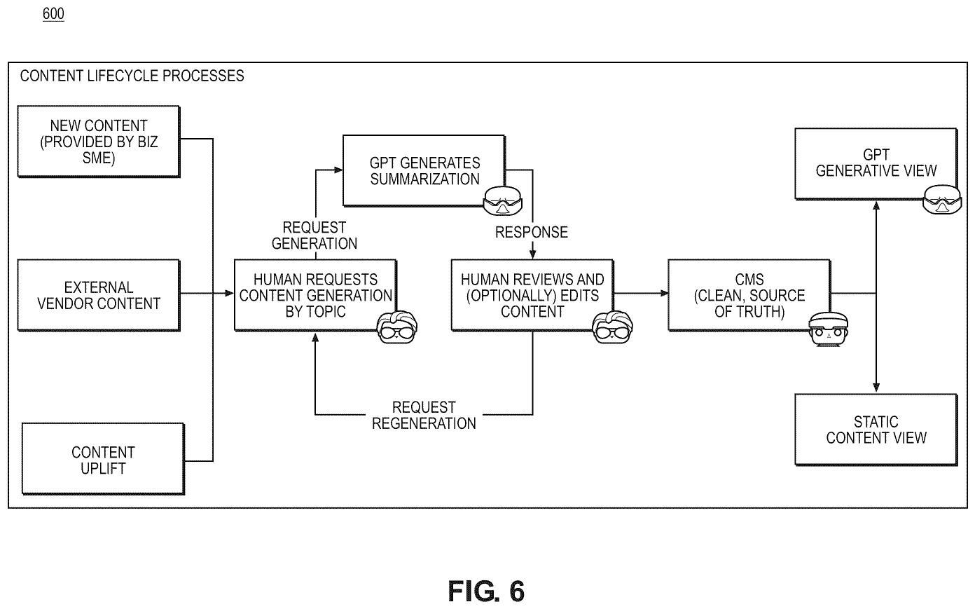

FIG. 6 is a content lifecycle process flow diagram of an exemplary process for implementing a method for facilitating artificial intelligence assisted content lifecycle management, artificial intelligence content restructuring, and artificial intelligence assisted authoring from subject matter generation to automated publishing. In FIG. 6, content lifecycle processes are disclosed consistent with present disclosures.

As illustrated in FIG. 6, new content, external vendor content, and content uplift may be provided to a user based on user inquiries. The user may interact with the disclosed system to request content generation by topic. Afirst model such as, for example, a generative pre-trained transformer (GPT) model may determine a response, which is provided to the user. The user may reject the generated content in the response and request regeneration of a new response. However, when the user accepts the generated content in the response, a second model may be used to clean the response to ensure that the generated content satisfies predetermined requirements such as, for example, an entity writing style guide. Once sufficiently refined, the generated content in the response may be presented to the user in a generative view and/or in a static content view.

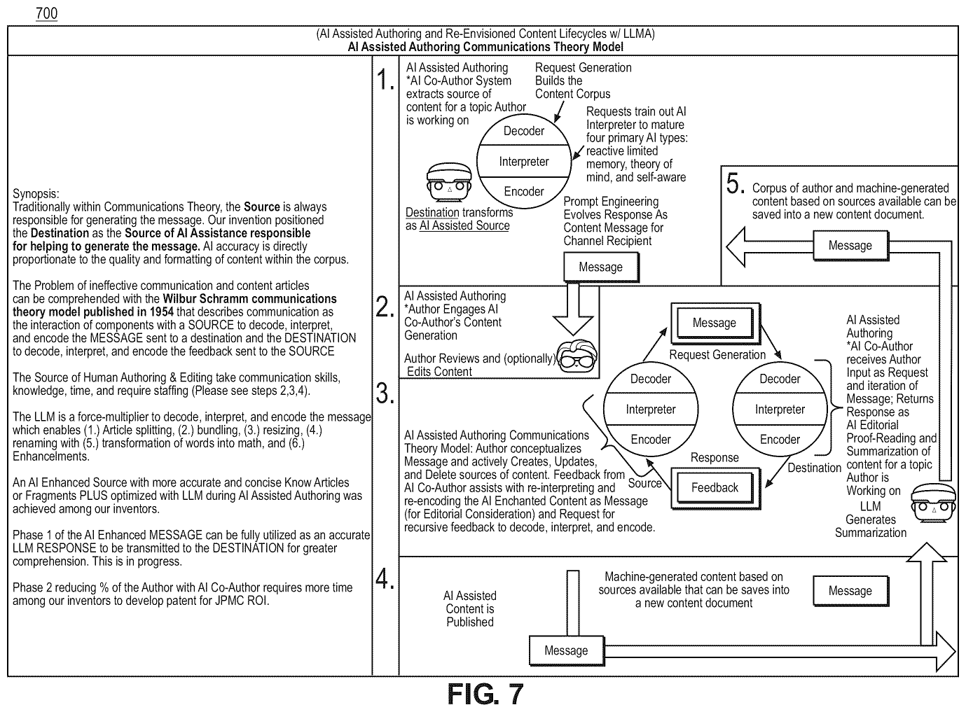

FIG. 7 is a theory model diagram of an exemplary process for implementing a method for facilitating artificial intelligence assisted content lifecycle management, artificial intelligence content restructuring, and artificial intelligence assisted authoring from subject matter generation to automated publishing. In FIG. 7, an artificial intelligence assisted authoring communications theory model is provided to graphically represent artificial intelligence assisted authoring and re-envisioned content lifecycle with large language models.

Accordingly, with this technology, an optimized process for facilitating artificial intelligence assisted content lifecycle management, artificial intelligence content restructuring, and artificial intelligence assisted authoring from subject matter generation to automated publishing is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for facilitating content lifecycle management via artificial intelligence, the method being implemented by at least one processor, the method comprising:
receiving, by the at least one processor via an application programming interface, at least one inquiry in a natural language format, each of the at least one inquiry including freeform data;
vectorizing, by the at least one processor, the at least one inquiry to generate at least one numeric sequence;
identifying, by the at least one processor using at least one model, at least one topic for each of the at least one inquiry based on the corresponding at least one numeric sequence, each of the at least one topic including a subject matter value and a sentiment value;
aggregating, by the at least one processor, information that corresponds to the at least one topic from at least one source, the at least one source including a preconfigured data lake;
determining, by the at least one processor using the at least one model, at least one solution in the natural language format for each of the at least one inquiry based on the aggregated information, the at least one solution including at least one recommended action based on a predetermined setting; and
generating, by the at least one processor using the at least one model, a response that includes the at least one solution.

2. The method of claim 1, further comprising:
displaying, by the at least one processor via a graphical user interface, the response together with at least one graphical element that is configured to receive a user input,
wherein the at least one graphical element includes at least one from among an edit graphical element that enables modification of the response, a regenerate response graphical element that generates a new response, an update response graphical element that incorporates the at least one recommended action into the response, and a publish graphical element that persists the response as documentation.

3. The method of claim 2, further comprising:
collecting, by the at least one processor, feedback data in real-time for each of the at least one inquiry,
wherein the feedback data includes feedback information that corresponds to the at least one solution, the at least one recommended action, and the user input.

4. The method of claim 3, further comprising:
determining, by the at least one processor, whether at least one data inconsistency exists in the response based on the collected feedback data, the at least one data inconsistency corresponding to a data point in the response;
updating, by the at least one processor, the response by removing the data point when the corresponding at least one data inconsistency is determined; and
training, by the at least one processor, the at least one model based on the updated response.

5. The method of claim 1, wherein the at least one recommended action includes at least one automatically generated prompt that represents the at least one topic, the at least one automatically generated prompt including a new phrasing that is different than the corresponding at least one inquiry.

6. The method of claim 1, wherein the at least one recommended action includes at least one from among an editorial action that relates to recommended phrasing based on a predetermined style guide, a proof-reading action that identifies a plurality of transcription errors, and a summarization action that outlines the at least one topic.

7. The method of claim 1, wherein the at least one solution is determined by using the at least one model based on the aggregated information and user historical data, the user historical data including at least one from among aggregated historical information from a plurality of users and personal historical information from a user.

8. The method of claim 1, further comprising:
initiating, by the at least one processor, at least one function to modify the information that corresponds to the at least one topic in the at least one source based on the at least one solution,
wherein the at least one function includes at least one from among a generation function, an update function, and a delete function.

9. The method of claim 1, the at least one model includes at least one from among a large language model, a deep learning model, a neural network model, a natural language processing model, a machine learning model, a mathematical model, and a process model.

10. A computing device configured to implement an execution of a method for facilitating content lifecycle management via artificial intelligence, the computing device comprising:
a processor;
a memory; and
a communication interface coupled to each of the processor and the memory,
wherein the processor is configured to:
receive, via an application programming interface, at least one inquiry in a natural language format, each of the at least one inquiry including freeform data;
vectorize the at least one inquiry to generate at least one numeric sequence;
identify, by using at least one model, at least one topic for each of the at least one inquiry based on the corresponding at least one numeric sequence, each of the at least one topic including a subject matter value and a sentiment value;
aggregate information that corresponds to the at least one topic from at least one source, the at least one source including a preconfigured data lake;
determine, by using the at least one model, at least one solution in the natural language format for each of the at least one inquiry based on the aggregated information, the at least one solution including at least one recommended action based on a predetermined setting; and
generate, by using the at least one model, a response that includes the at least one solution.

11. The computing device of claim 10, wherein the processor is further configured to:
display, via a graphical user interface, the response together with at least one graphical element that is configured to receive a user input,
wherein the at least one graphical element includes at least one from among an edit graphical element that enables modification of the response, a regenerate response graphical element that generates a new response, an update response graphical element that incorporates the at least one recommended action into the response, and a publish graphical element that persists the response as documentation.

12. The computing device of claim 11, wherein the processor is further configured to:
collect feedback data in real-time for each of the at least one inquiry,
wherein the feedback data includes feedback information that corresponds to the at least one solution, the at least one recommended action, and the user input.

13. The computing device of claim 12, wherein the processor is further configured to:
determine whether at least one data inconsistency exists in the response based on the collected feedback data, the at least one data inconsistency corresponding to a data point in the response;
update the response by removing the data point when the corresponding at least one data inconsistency is determined; and
train the at least one model based on the updated response.

14. The computing device of claim 10, wherein the at least one recommended action includes at least one automatically generated prompt that represents the at least one topic, the at least one automatically generated prompt including a new phrasing that is different than the corresponding at least one inquiry.

15. The computing device of claim 10, wherein the at least one recommended action includes at least one from among an editorial action that relates to recommended phrasing based on a predetermined style guide, a proof-reading action that identifies a plurality of transcription errors, and a summarization action that outlines the at least one topic.

16. The computing device of claim 10, wherein the processor is further configured to determine the at least one solution by using the at least one model based on the aggregated information and user historical data, the user historical data including at least one from among aggregated historical information from a plurality of users and personal historical information from a user.

17. The computing device of claim 10, wherein the processor is further configured to:
initiate at least one function to modify the information that corresponds to the at least one topic in the at least one source based on the at least one solution,
wherein the at least one function includes at least one from among a generation function, an update function, and a delete function.

18. The computing device of claim 10, wherein the at least one model includes at least one from among a large language model, a deep learning model, a neural network model, a natural language processing model, a machine learning model, a mathematical model, and a process model.

19. A non-transitory computer readable storage medium storing instructions for facilitating content lifecycle management via artificial intelligence, the storage medium comprising executable code which, when executed by a processor, causes the processor to:
receive, via an application programming interface, at least one inquiry in a natural language format, each of the at least one inquiry including freeform data;
vectorize the at least one inquiry to generate at least one numeric sequence;
identify, by using at least one model, at least one topic for each of the at least one inquiry based on the corresponding at least one numeric sequence, each of the at least one topic including a subject matter value and a sentiment value;
aggregate information that corresponds to the at least one topic from at least one source, the at least one source including a preconfigured data lake;
determine, by using the at least one model, at least one solution in the natural language format for each of the at least one inquiry based on the aggregated information, the at least one solution including at least one recommended action based on a predetermined setting; and
generate, by using the at least one model, a response that includes the at least one solution.

20. The storage medium of claim 19, wherein, when executed by the processor, the executable code further causes the processor to:
display, via a graphical user interface, the response together with at least one graphical element that is configured to receive a user input,
wherein the at least one graphical element includes at least one from among an edit graphical element that enables modification of the response, a regenerate response graphical element that generates a new response, an update response graphical element that incorporates the at least one recommended action into the response, and a publish graphical element that persists the response as documentation.
